(19) United States
(12) Patent Application Publication
(10) Pub. No.: US 2007/0209122 A1
(43) Pub. Date: Sep. 13, 2007

(54) Mixed gas refrigerants

(76) Inventor: Lawrence Sobel, Tucson, AZ (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 11/374,806

(22) Filed: Mar. 13, 2006

(51) Int. Cl. C11D 3/00

(52) U.S. Cl. 8/137

(57) ABSTRACT

The present invention generally discloses multi-component gas mixtures suitably adapted to provide condensed phase cryogenic refrigerants with normal boiling point temperatures below approximately 80° K. Exemplary gas mixture components typically include: 5-40% argon and 60-80.0% neon.

### FIELD OF INVENTION

The present invention generally concerns refrigerants; and more particularly, representative and exemplary embodiments of the present invention generally relate to mixed gas refrigerants for use below 77 K.

### BACKGROUND OF INVENTION

Freon-type pure gases have been generally used in closed-cycle refrigeration systems operating within household and commercial refrigeration temperature regimes. More recently, mixed gases (frequently utilizing Freon as one of the constituent components) have also been employed. Such consumer-level refrigeration systems typically employ equipment that is suitably adapted to operate within desired pressure ratios and temperature ranges.

When operating cooling systems in cryogenic temperature regimes, condensed phase refrigerants having normal boiling point temperatures below 120K (e.g., nitrogen, helium, methane, and the like) have been used. These cryogenic gases have ordinarily required the use of high pressure gas systems involving multi-stage compressors or high pressure oil-less compressors. Accordingly, these systems have become more expensive to manufacture and operate, and require frequent maintenance.

In order to provide cryogenic systems which are less costly and more efficient, there have been mixed gas refrigerants proposed for use within cryogenic temperature ranges. Many such mixed gas systems have been proposed. These typically combine conventional and well-known cryogenic refrigerants with various hydrocarbons, including methane, ethane, propane, and isobutene, in various combinations.

U.S. Pat. No. 5,441,658 to Boyarsky et al discloses mixed gas refrigerants consisting of mixtures of 30-50% by molar weight of nitrogen combined with at least some, but less than 20% methane by mole fraction, at least 30% propane by mole fraction, and enough ethane or ethylene to balance the mixture. Russian Patent No. 627,154 suggests a mixed gas refrigerant combining nitrogen with various hydrocarbons (e.g., 25-40% nitrogen by molar weight, 20-35% methane by molar weight, 15-35% ethane by molar weight, and 25-45% propane by molar weight. Another reference which has suggested a combination of the same ingredients, but in different proportions, is U.K. Patent No. 1,336,892.

There are numerous combinations of conventional cryogenic refrigerants. The existing systems, however, are generally only suitable for operation above about 80K.

Conventional cryogenic fluids with normal boiling points above about 80K generally include: N₂, air, CO, F, Ar, O₂, CH₄, Kr, R14, O₃, Xe, C₂H₄, BF₃, N₂O, C₂H₆, HCl, C₂H₂, CHF₃, 1,1-C₂H₂F₂, R13, CO₂, Rn, C₃H₈, C₄H₁₀, and C₅H₁₂. Those with normal boiling points below about 27K generally include ³He, ⁴He, H₂, ²H, ³H, and Ne. For cryogenic applications between 27K and 80K, none of these pure compounds provide a suitable condensed phase normal boiling point temperature.

### SUMMARY OF THE INVENTION

In various representative aspects, the present invention discloses multi-component gas mixtures suitably adapted to provide condensed phase cryogenic refrigerants with normal boiling points below 80K. Exemplary gas mixture components typically include: 22-30% nitrogen; 19-40% argon; 20.1-80.5% neon; and 9.5-9.9% carbon monoxide. The disclosed multi-component gas mixtures may be suitably adapted (with varying component mass ratios) for operation between about 27K (100% Neon) and about 80K (100% N₂).

Advantages of the present invention will be set forth in the Detailed Description which follows and may be apparent from the Detailed Description or may be learned by practice of exemplary embodiments of the invention. Still other advantages of the invention may be realized by means of any of the instrumentalities, methods or combinations particularly pointed out in the claims.

### DETAILED DESCRIPTION OF EXEMPLARY EMBODIMENTS

The following representative descriptions of the present invention generally relate to exemplary embodiments and the inventor's conception of the best mode, and are not intended to limit the scope, applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

A detailed description of a representative multi-component gas mixture is provided as a specific enabling disclosure that may be generalized to any operational embodiment of the disclosed invention.

In a representative embodiment, approximately 9.5% CO by molar weight is combined with about 22% N₂ by molar weight, about 19% Ar by molar weight, and balanced with Ne. The resulting multi-component mixture has a normal boiling point temperature of approximately 49° K.

In another representative embodiment, approximately 9.9% CO by molar weight is combined with about 30% N₂ by molar weight, about 40% by molar weight Ar, and balanced with Ne. The resulting multi-component mixture has a normal boiling point temperature of approximately 60° K.

Other exemplary mixtures may be developed for temperature-specific applications (e.g., such as those requiring temperatures between about 27° K and 80° K) by mixing at least one gaseous compound (e.g., CO) with at least one pure component selected from the group consisting of N₂, Ar, and Ne, as well as combinations thereof.

In the foregoing specification, the invention has been described with reference to specific exemplary embodiments; however, it will be appreciated that various modifications and changes may be made without departing from the scope of the present invention as set forth in the claims below. The specification is to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

For example, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprising”, “having”, “including” or any contextual variant thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

We claim:

1. A mixed gas composition suitably adapted to provide a condensed phase refrigerant having a normal boiling point below about 80° K, said composition consisting essentially of: Ar and Ne.

2. The composition of claim 1, wherein the molar weight fraction of Hydrocarbons is between about 9.5% to about 9.9%.

3. The composition of claim 1, wherein the molar weight fraction of N₂ is between about 22% to about 30%.

4. The composition of claim 1, wherein the molar weight fraction of Ar is between about 19% to about 40%.

5. The composition of claim 1, wherein the molar weight fraction of Ne is between about 20.1% to about 81.0%.

6. The composition of claim 1, wherein:
the molar weight fraction of Ar ranges from about 19% to about 40%; and
the molar weight fraction of Ne ranges from about 20.1% to about 81.0%.

7. The composition of claim 1, wherein the normal boiling point of the condensed phase mixture is between about 27° K and 77° K.

8. The composition of claim 1, wherein said hydrocarbons comprise at Least one of CO, CH₄, C₃H₈, C₄H₁₀, and C₅H₁₂.

9. A method for providing a condensed phase refrigerant having a normal boiling point below about 80° K, said method comprising the step of providing a mixed gas consisting essentially of: Ar and Ne.

10. The method of claim 9, wherein the molar weight fraction of hydrocarbons is between about 9.5% to about 9.9%.

11. The method of claim 9, wherein the molar weight fraction of N₂ is between about 22% to about 30%.

12. The method of claim 9, wherein the molar weight fraction of Ar is between about 19% to about 40%.

13. The method of claim 9, wherein the molar weight fraction of Ne is between about 20.1% to about 49.5%.

14. The method of claim 9, wherein:
the molar weight fraction of Ar ranges from about 19% to about 40%; and
the molar weight fraction of Ne ranges from about 20.1% to about 80.1%.

15. The method of claim 9, wherein the normal boiling point of the condensed phase mixture is between about 27° K and 77° K.

16. The method of claim 9, wherein said hydrocarbons comprise at least one of CO, CH₄, C₃H₈, C₄H₁₀, and C₅H₁₂.

17. A mixed gas composition suitably adapted to provide a condensed phase refrigerant having a normal boiling point of about 50° K, said composition consisting essentially of:
about 80.5% Ne by molar weight fraction.
